(19) United States
(12) Patent Application Publication
(10) Pub. No.: US 2015/0377338 A1
(43) Pub. Date: Dec. 31, 2015

(54) GEARBOX HOUSING AND METHOD FOR PRODUCING A GEARBOX HOUSING

(71) Applicant: Magna Powertrain AG & Co KG, Lannach (AT)

(72) Inventors: Alexander DIETRICH, Ehrenhausen (AT); Heinz Karl KLAMPFL, Bärnbach (AT); Markus REITERER, Gleisdorf (AT)

(21) Appl. No.: 14/768,019

(22) PCT Filed: Jan. 22, 2014
(86) PCT No.: PCT/EP2014/051214

§ 371 Date: Aug. 14, 2015

(30) Foreign Application Priority Data
Feb. 22, 2013 (DE) 10 2013 202 952.7

(51) Int. Cl. F16H 57/029; B23K 20/12

(52) U.S. Cl. CPC F16H 57/029; B23K 20/122; B23K 20/127

(57) ABSTRACT

A gear housing comprised of a first gear housing portion and a second gear housing portion, wherein the first gear housing portion and the second gear housing portion are permanently connected to each other by means of a friction stir welding connection, and a corresponding method for producing such a gear housing.

### CROSS-REFERENCE TO RELATED APPLICATIONS

This application is a National Stage of International application Ser. No. PCT/EP2014/051214 filed Jan. 22, 2014 and which claims the benefit and priority of German Application No. DE10 2013 202 952.7 filed on Feb. 22, 2013. The entire disclosure of each of the above applications is incorporated herein by reference.

### TECHNICAL FIELD

The present invention relates to a gear housing comprising a first gear housing portion and a second gear housing portion and a method for producing a gear housing comprising a first gear housing portion and a second gear housing portion.

### BACKGROUND

Such gear housings are used in particular in vehicle technology and serve, for example, to receive gearboxes, axle gears or distribution gears. The gear housings are mostly composed of two gear housing portions. In this instance, usually after installation of the gear portions in at least one of the gear housing portions, the two gear housing portions are connected to each other in an operationally secure manner. For connection, screws and dowel pins or spring pins are generally used. For the retention of the screws, accumulations of material are required in the region of the connection, such as screw domes. For the protection of these material accumulations, protection ribs, which also have a reinforcing effect, are in turn provided in the region of the screw connections. The connection region has to be sealed by means of sealing materials in liquid or solid form in order, for example, to prevent the discharge of oil from the gear housing.

Gear housings of the construction type described require a large amount of structural space and are heavy.

DE 10 2007 053 516 A1 discloses a gear housing having a first gear housing portion and a second gear housing portion which are connected to each other in a non-releasable manner. In particular, the gear housing portions may be welded to each other. However, gear housings which comprise gear housing portions which are connected to each other by means of conventional welding methods are, in a manner dependent on the materials of the gear housing portions, only suitable to an insufficient extent for producing operationally secure and oil-tight connections of gear housing portions.

Friction stir welding is a known welding method which is also used for the connection of housing components. U.S. 20080067216 A1 thus discloses a method for connecting housing portions, in which components are welded to each other using a reinforcement structure.

### SUMMARY

An object of the invention is to improve gear housings and in particular to provide a gear housing which requires little structural space, is light and has good strength and good acoustic properties and fluid-tightness. It is also an object of the invention to provide a method for producing a gear housing which is improved in this manner.

The object is achieved by a gear housing comprising a first gear housing portion and a second gear housing portion, wherein the first gear housing portion and the second gear housing portion are permanently connected to each other by means of a friction stir welding connection. In this instance, the gear housing portions are butt-connected to each other by means of flanges, wherein at least the outer shoulders of the flanges comprise unprocessed cast material.

The object is also achieved by a method for producing a gear housing comprising a first gear housing portion and a second gear housing portion, wherein the first gear housing portion and the second gear housing portion are provided and subsequently the first gear housing portion and the second gear housing portion are permanently connected to each other by means of friction stir welding.

According to the invention, the two gear housing portions are joined to each other by means of friction stir welding by means of flanges. It is thereby possible to dispense with material accumulations for screw connections. The region of the friction stir welding connection where the two flanges abut can be constructed in a regular manner, that is to say, so as to extend in particular along the weld seam in a continuous and smooth manner, since neither screws nor accumulations of material are required for the screw connection.

No reinforcement ribs also have to be provided for the protection of such material accumulations. The flanges are constructed in such a manner that the forces are not directed away at screw domes or dowel pin seats but instead are distributed over the entire flange. The weld seam of the friction stir welding connection can be constructed in a tight manner so that no additional sealing is required in the region of the weld seam.

As a result of the use of stir friction welding for joining the gear housing portions, there is produced, in comparison with other welding methods, a very small thermal input so that only a minimal distortion occurs at the gear housing portions. The gear housings according to the invention further have as a result of a positive change of the structure in the friction stir welding region a high level of strength with low weight.

The material of the inner support faces of the flanges may also comprise unprocessed cast material. The first gear housing portion and the second gear housing portion do not have to be constructed in a rotationally symmetrical manner.

The gear housing advantageously has a thickened portion which is located in the region of the flange. It serves to carry the discharge hole of the friction stir welding tool.

Advantageously, more than the angle 360° is welded, that is to say, the starting point is overwelded.

The first gear housing portion may comprise a different material from that of the second gear housing portion in order to combine the advantageous properties of different materials, for example, with regard to strength and weight. Since, during friction stir welding, the material of the first gear housing portion in comparison with the material of the second gear housing portion may have a different melting point, the materials can be selected in accordance with other desired properties.

In particular, the first gear housing portion may comprise steel and the second gear housing portion may comprise aluminum.

In another embodiment, the first gear housing portion may comprise steel and the second gear housing portion may comprise magnesium.

In another embodiment, the first gear housing portion may comprise magnesium and the second gear housing portion may comprise aluminum.

In a particularly preferred manner, the first gear housing portion and the second gear housing portion comprise the same material, whereby a particularly cost-effective production is enabled. The first gear housing portion and the second gear housing portion may also comprise steel, aluminum or magnesium in this case in which materials of the same type are used.

In a particularly preferred manner, the first gear housing portion and/or the second gear housing portion is a die-cast component. Optimal properties with regard to costs, weight and rigidity are thereby achieved.

One of the gear housing portions may be a cover, in particular of die-cast aluminum or die-cast magnesium.

No rib is preferably arranged in the region of the friction stir welding connection since protection ribs are not required in this region and other positions of ribs may be better suited to optimize the properties of the gear housing. Ribs and wall reinforcements may exclusively be positioned on the gear housing portions at locations where they contribute in an optimum manner to the rigidity of the gear housing and to the NVH (Noise Vibration Harshness) behavior of the gear housing, that is to say, to the acoustic properties thereof.

To this end, there is/are preferably constructed on the first gear housing portion and/or on the second gear housing portion at least one rib, in particular a plurality of ribs.

In order to produce a gear housing comprising a first gear housing portion and a second gear housing portion, the first gear housing portion and the second gear housing portion are provided and subsequently the first gear housing portion and the second gear housing portion are connected to each other permanently by means of friction stir welding, wherein the housing portions are butt-connected to each other by means of flanges and the friction stir welding tool is placed on the outer unprocessed shoulder of the flanges.

Preferably, the weld seam is smoothed and/or deburred during the friction stir welding operation, in particular this can be carried out during the welding operation by means of a tool structure, such as a tool shoulder of the friction stir welding device. The weld seam can also be polished after the friction stir welding.

Advantageously, the welding is carried out over more than 360° and the weld tool is guided radially outward on a thickened portion of the flange.

In order to prepare the weld operation, the gear housing portions may be fixed to each other by means of dowel pins.

It is advantageous in this instance for the friction stir welding tool to be able to bridge gaps between the flanges of up to several millimeters and to nonetheless be able to connect the housing portions in a tight manner.

Developments of the invention are set out in the dependent claims, the description and the appended drawings.

### DRAWINGS

The invention is described below by way of example with reference to the drawings, in which:

FIG. 1 is a three-dimensional schematic illustration of a gear housing according to the prior art,

FIG. 2 is a three-dimensional schematic illustration of a gear housing according to the invention,

FIG. 3 is a plan view of the gear housing, and

FIG. 4 is a cross-section through the weld seam.

### DESCRIPTION

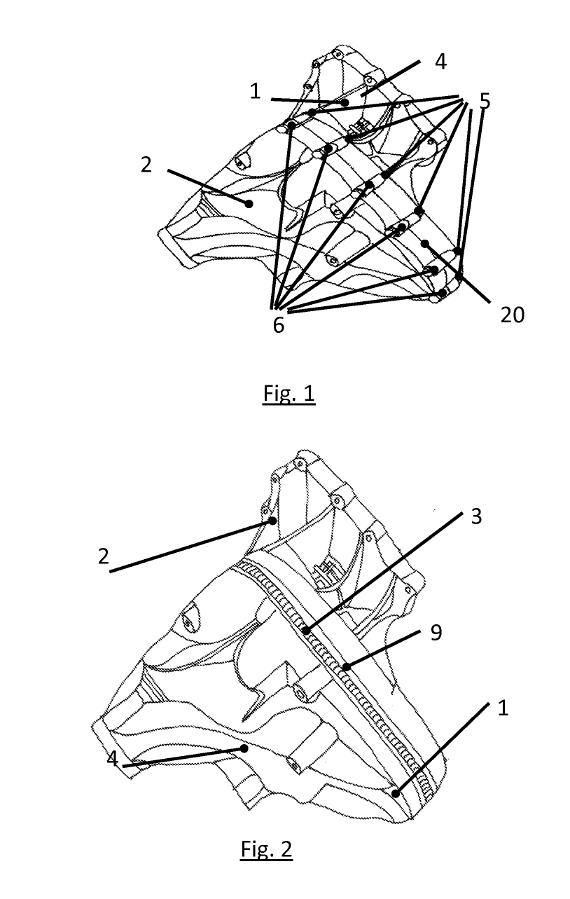

FIG. 1 illustrates a gear housing which is already known from the prior art and which is composed of a first gear housing portion 1 and a second gear housing portion 2. In order to connect the gear housing portions 1 and 2, screw domes with screws 6 are used. In order to secure the screw domes with screws 6, in particular against risks in the event of collisions, ribs 5 are constructed as protection ribs in the region of these material accumulations. These protection ribs may further also serve to direct forces to be transmitted directly and in a concentrated manner via screws or dowel pins. However, the position thereof, as a result of the protective function against collisions cannot be selected freely or optimally with respect to the force transmission function thereof. The separation face between the first and the second gear housing portion 1, 2 is sealed by means of a seal 20.

FIG. 2 illustrates a gear housing according to the invention. The gear housing comprises a first gear housing portion 1 and a second gear housing portion 2 which may comprise different materials. The first gear housing portion 1 is permanently connected to the second gear housing portion 2 by means of a friction stir welding connection 3. The friction stir welding connection 3 forms together with the first and second gear housing portion 1, 2 a uniform surface. A seal is not required in this region. Both on the first gear housing portion 1 and on the second gear housing portion 2, ribs 4 are arranged in such a manner that they contribute in an optimum manner to increasing the rigidity and to good NVH (Noise Vibration Harshness) properties. Protection ribs in the region of the friction stir welding connection 3 are not provided.

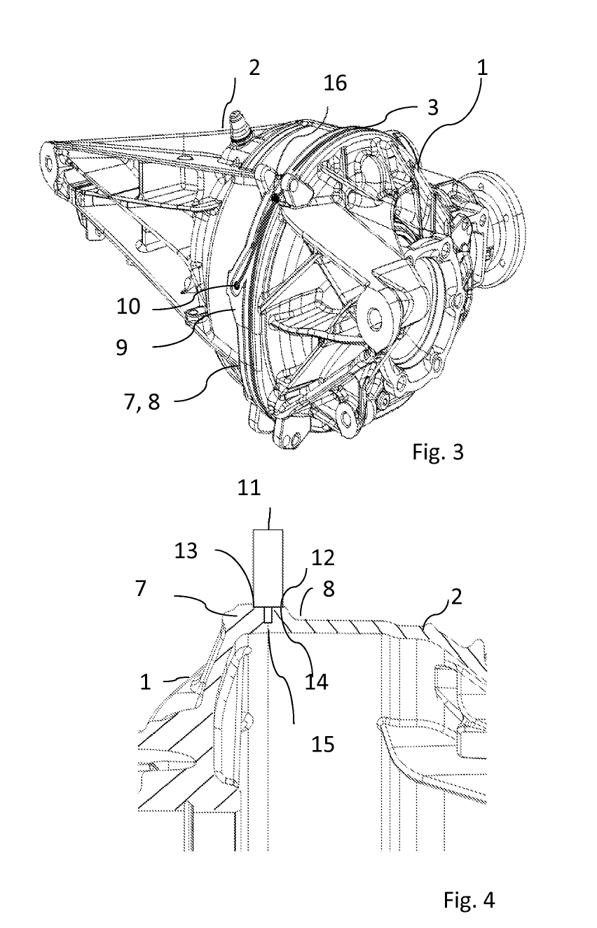

FIG. 3 is a view of a gear housing having the two housing components 1 and 2. They are butt-joined to each other by means of the respective flanges 7, 8. At a location of the flange connection, there is radially formed a thickened portion 9 which has a radial extent in the region of one of the flanges. In this instance, it is not relevant whether the thickened portion is constructed at the flange side on the housing component 1 or 2. Within the thickened portion, a discharge hole 10 can be seen. The two components are joined to each other by means of a weld seam, which extends continuously along the flanges. Beginning at a starting point 16, the friction stir welding tool with the rapidly rotating pin thereof is guided in an annular manner along the flanges 7, 8 and then in the region of the thickened portion radially outward.

FIG. 4 shows in cross-section how the joining location of the gear housing portions 1, 2 is constructed. The gear housing portions terminate in each case in a flange which is constructed by means of a greater material thickness. The forces can thereby be introduced into the joining location in a uniform and homogeneous manner. As a result of the increase of the material thickness in the region of the flange, there are formed faces which, when placed one against the other, form the gap 15 to be joined. Shoulders 12, 13 are formed at the outer sides of the flanges 7, 8. The lower abutment member 14 of the friction stir welding tool 11 is in abutment with those shoulders 12, 13. The shoulders do not have to be pre-processed for the joining operation by means of the friction stir welding. They may comprise the unprocessed surface of the cast component. The friction stir welding can in this instance tolerate roughness of up to a few millimeters, for a better quality up to 1.5 mm. A processing step can thereby be dispensed with and the joining process can be used directly on the cast component. The skin of the cast component which is always produced for technical production reasons is also no problem since it is incorporated in a homogeneous manner in the metal matrix during the friction stir welding operation by the plasticizing and mixing action of the tool. The surfaces which delimit the gap 15 may also be rough and unprocessed. In this instance, the friction stir welding also permits a gap of several millimeters, but certainly up to one millimeter.

For the joining process, the gear housing portions 1 and 2 can be positioned against each other with dowel pins. Subsequently, the friction stir welding tool is positioned and the pin of the tool which, when the shoulders are positioned, is introduced into the workpiece surface, is guided along the flange line. The starting point is in this instance overwelded and the tool guided at least a further several angular degrees beyond 360° along the existing weld seam. In this instance, the tool is slowly guided outward in the direction toward a thickened portion 9. The welding operation ends at that location with the mandrel being lifted and the discharge hole being left.

As a result of the fact that the discharge hole is produced at a defined location outside the annular welding, the welding remains impermeable.

### LIST OF REFERENCE NUMERALS

1 First gear housing portion
2 Second gear housing portion
3 Friction stir welding connection
4 Rib
5 Rib
6 Screw dome with screws
7 Flange housing portion 1
8 Flange housing portion 2
9 Thickened portion
10 Discharge hole
11 Friction stir welding tool
12 Shoulder flange 8
13 Shoulder flange 7
14 Lower abutment member (tool shoulder)
15 Gap
16 Starting point
20 Seal

1-14. (canceled)

15. A gear housing comprising a first gear housing portion and a second gear housing portion, wherein the first gear housing portion and the second gear housing portion are permanently connected to each other by means of a friction stir welding connection, wherein the gear housing portions are butt-connected to each other by means of flanges, and wherein at least outer shoulders of the flanges comprise unprocessed cast material.

16. The gear housing as claimed in claim 15, wherein the flanges are configured in such a manner that they absorb forces on the gear housing in an extensive manner.

17. The gear housing as claimed in claim 15, wherein the first gear housing portion comprises a different material from that of the second gear housing portion.

18. The gear housing as claimed in claim 15 , wherein at least one of the inner support faces of the flanges comprises THE unprocessed cast material.

19. The gear housing as claimed in claim 15, wherein one of the housing portions has a radial thickened portion in the region of the flange.

20. The gear housing as claimed in claim 19, wherein the radial thickened portion contains a discharge hole of the friction stir welding tool.

21. The gear housing as claimed claim 15, wherein the region of the friction stir welding connection is constructed in an annular manner over more than 360°.

22. The gear housing as claimed in claim 15, wherein no rib is arranged in the region of the friction stir welding connection.

23. A method for producing a gear housing comprising a first gear housing portion and a second gear housing portion, wherein the first gear housing portion and the second gear housing portion are provided and subsequently the first gear housing portion and the second gear housing portion are permanently connected to each other by means of a weld seam generated by a friction stir welding operation, and wherein the gear housing portions are positioned on each other in an abutting manner by means of flanges and a friction stir welding tool is positioned with a shoulder thereof on outer unprocessed shoulders of the flanges.

24. The method as claimed in claim 23, wherein the weld seam is smoothed and/or deburred by friction stir welding.

25. The method as claimed in claim 23, wherein the weld seam extends in an annular manner over an angle of more than 360°.

26. The method as claimed in claim 23, wherein the weld seam is guided beyond the starting point and extends radially outward into a thickened portion.

27. The method as claimed in claim 23, wherein the gear housing portions are fixed by means of dowel pins prior to the welding operation.

28. The method as claimed in claim 23, wherein the friction stir welding tool bridges a gap of up to 1 mm between the flanges and connects the gear housing portions in a tight manner.
